(19) United States
(12) Patent Application Publication
(10) Pub. No.: US 2009/0067832 A1
(43) Pub. Date: Mar. 12, 2009

(54) Method and Apparatus for Verifying Signaling Values in an Optical Distribution Network

(75) Inventors: David A DeLew, Rohnert Park, CA (US); Vinita Gupta, San Rafael, CA (US); Robert S. Larvenz, Rohnert Park, CA (US); Manie C. Steyn, Sebastopol, CA (US); Ryan D. Houlgate, Windsor, CA (US)

Correspondence Address: James M. Wu;JW Law Group, 84 W. Santa Clara Street, Suite 820, San Jose, CA, 95113, US

(73) Assignee: Tellabs Petaluma, Inc., Naperville, IL (US)

(21) Appl. No.: 11/852,999

(22) Filed: Sep. 10, 2007

(51) Int. Cl. H04B 10/08

(52) U.S. Cl. 398/25

(57) ABSTRACT

An apparatus and a method for verifying optical system performance using a signaling value test are disclosed. After instructing the first optical interface device and the second optical interface device to enter a verification mode, the first optical interface device sends first verification data to the second optical interface device via an optical communications network. In one embodiment, the first optical interface device is an optical line termination (“OLT”) and the second optical interface device is an optical network terminal (“ONT”). Upon composing the first reply message in response to content received by the second optical interface in accordance with the first verification data, the second optical interface device forwards the first reply message to the first optical interface device.

### FIELD

The exemplary embodiment(s) of the present invention relates to optical communications networks. More specifically, the exemplary embodiment(s) of the present invention relates to enhancing testing capabilities in an optical communications network.

### BACKGROUND

With increasing demand of more information to be supplied to homes and/or businesses, many network communication providers are switching or upgrading their networks to optical communications networks. In order to supply more information in the form of video, audio and telephony at higher rates, higher bandwidth communication networks are required. Optical communications networks can typically support high speed audio, video, and data transmission to/from homes and/or businesses. Typical example of optical network architecture may be fiber to the x (“FTTX”), which includes fiber to the node/neighborhood (“FTTN”), fiber to the curb (“FTTC”), fiber to the building (“FTTB”), fiber to the home (“FTTH”) or other edge location to which a fiber network extends.

Various components of an optical distribution network (“ODN”) including optical line termination (“OLT”) and optical network terminals (“ONTs”) can malfunction due to various hardware as well as software failures. For example, an ODN transmits commands or signaling values incorrectly and/or sometimes transmits frozen command(s). As a result, such malfunctions often result in loss of communications on a particular optical channel or an ONT. A conventional PON system, for example, can typically facilitate multiple communications such as multiple ONTs transmit data to an OLT using a common optical wavelength and fiber optic media. A malfunctioning OLT, for instance, may send corrupted signaling values to an ONT resulting in incorrect operation(s) of the ONT. Although a typical PON system provides some functionality for error detection, various types of errors, which appear to be correct signaling values but incorrect timing, are undetected. For instance, a typical PON system may not detect an error if a phone rings continuously because it receives a valid ringing signaling value with an invalid length of ringing time.

A conventional error detection technique implemented in accordance with G.983.1 for detecting malfunctioning devices is to force various signaling values from one end of an optical channel to another end of the optical channel such as from an OLT to an ONT. Every connecting point of the optical channel including the OLT and ONTs is individually checked manually to verify if the signaling values reach to their destination(s) correctly.

Another conventional error detection technique is to disconnect every ODN from an optical channel and then manually examine each discounted ODN with one or more optical signal test equipments to verify the performance of the network. This currently available testing technique is unable to determine the identity of a malfunctioning ONT and/or OLT.

### SUMMARY

A method and apparatus for verifying system performance using signaling test values in an optical communications network are described. After instructing the first optical interface device and the second optical interface device to enter a verification mode, the first optical interface device sends first verification data to the second optical interface device via an optical communications network. In one embodiment, the first optical interface device is an optical line termination (“OLT”) and the second optical interface device is an optical network terminal (“ONT”). Upon composing the first reply message in response to content received by the second optical interface in accordance with the first verification data, the second optical interface device forwards the first reply message to the first optical interface device.

Additional features and benefits of the exemplary embodiment(s) of the present invention will become apparent from the detailed description, figures and claims set forth below.

### BRIEF DESCRIPTION OF THE DRAWINGS

The exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIGS. 1A-B illustrate an optical communications network using a signaling value verification mechanism in accordance with one embodiment of the present invention;

FIG. 2 is a block diagram illustrating an optical communication network using a signaling value verification mechanism in accordance with one embodiment of the present invention;

FIG. 3 is a flowchart illustrating a process of using a signaling value verification mechanism to verify system performance in accordance with one embodiment of the present invention; and

FIG. 4 is a flowchart illustrating an alternative example of a signaling value verification mechanism to verify system performance in accordance with one embodiment of the present invention.

### DETAILED DESCRIPTION

Exemplary embodiment(s) of the present invention is described herein in the context of a method, system and apparatus of verifying system performance using signaling test values over an optical communications network. Those of ordinary skilled in the art will realize that the following detailed description of the exemplary embodiment(s) is illustrative only and is not intended to be in any way limiting. Other embodiments will readily suggest themselves to such skilled persons having the benefit of this disclosure. Reference will now be made in detail to implementations of the exemplary embodiment(s) as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skilled in the art having the benefit of this disclosure.

A signaling value verification mechanism verifies system performance and/or detects system failures using a sequence of signaling values over an optical communications network. Upon receipt of a testing request, the first optical interface device and the second optical interface device are instructed to enter a verification or test mode. The testing request, for example, may be issued by a network operator or by a scheduling program preloaded to a control system. The first optical interface network, in one embodiment, is an optical line termination (“OLT”) and the second optical interface device is an optical network terminal (“ONT”). The first optical interface device subsequently sends first verification data to the second optical interface device via an optical communications network. Upon receipt of the content relating to the first verification data, the second optical interface device determines whether it has received the correct first verification data from the first optical interface device. Upon composing the first reply message in response to the content received by the second optical interface in connection to the first verification data, the second optical interface device forwards the first reply message to the first optical interface device. The first reply message, in one embodiment, informs the first optical interface device that the second optical interface device received the first verification data correctly or incorrectly.

It should be noted that signaling values, in one embodiment, are network commands and instructions. The signaling value verification mechanism can be referred to as an enhanced error detecting algorithm, which is capable of isolating network failures. For example, if an enhanced error detecting algorithm is incorporated into a standard error detection method under a standard protocol such as ITU G.983.1, the enhanced error detection method is capable of isolating various error conditions such as incorrect signaling values as well as frozen signaling values. Upon isolating or detecting the incorrect signaling value(s), an alarm may be raised to alert the network operator of such failure(s).

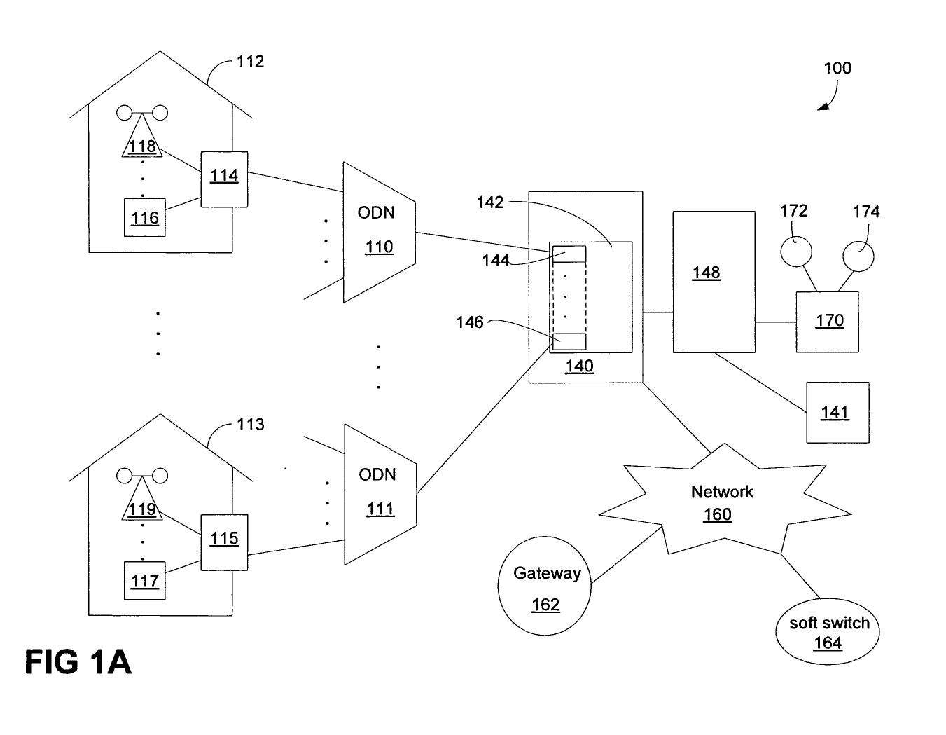

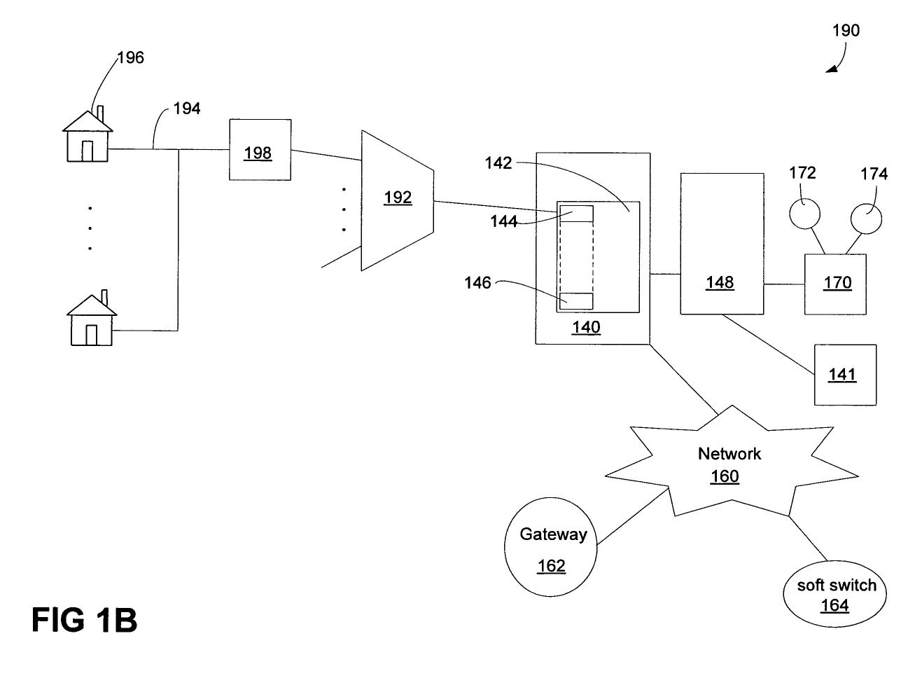

FIG. 1A illustrates an optical communications network 100 using a signaling value verification mechanism in accordance with one embodiment of the present invention. Network 100 is a fiber to the premises (“FTTP”) optical network architecture, which distributes optical signals from a central office 140 to one or more optical network terminals or optical network terminations (“ONTs”). ONTs generally reside at customers' or users' premises 112-113. Network 100 further includes NMS 148, central offices 140-141, a network connection 160, optical distribution networks (“ODNs”) 110-111, and ONTs 114-115. Network connection 160 can be used to connect to a video network or wireless network and it may further optionally coupled to a gateway device 162 and a soft switch 164.

Central office 140, for example, further includes an optical line termination (“OLT”) 142. Each OLT 142 is capable of supporting a group of passive optical networks (“PONs”) 144-146 wherein each one of PONs 144-146 is further capable of coupling one or more ODNs. Each ODN provides optical data transmission between a PON and a group of ONTs. For example, the group of ONTs may include anywhere from 1 to 64 ONTs. Alternatively, a PON may support more than 64 ONTs depending on the layout of the optical network. NMS 148 is coupled to central offices 140-141, and a server 170. Server 170 is coupled to users 172-174 wherein users 172-174 can be network operators and/or other servers (or processing devices). A function of NMS 148 is to display network information to the NMS client such as users 172 or 174 via server 170.

ONT 114, as shown in FIG. 1A, is physically situated at customer's premise 112, wherein premise 112 further includes various local communication devices (or equipments) such as voice device 118 and device 116. While voice device 118 may be a wired or wireless voice device, device 116 may be a personal computer, a set-top-box (“STB”), or a modem. A function of ONT is to convert signal format between optical signals and electrical signals. For instance, ONT 114 receives optical signals from a corresponding ODN 110 and subsequently converts the optical signals to electrical signals before the electrical signals are being transmitted to devices 116 and 118. Similarly, ONT 114 receives electrical signals from local devices 116 and/or 118, and then converts the electrical signals to optical signals before being transmitted to ODN 110. It should be noted that ONT 115 is coupled to local devices 117-119 at customer's premise 113 and performs similar functions as ONT 114.

OLT 142 is located at central office 140 and is coupled to multiple PONs 144-146. OLT 142, in one aspect, can be considered as the endpoints for PONs 144-146. For example, OLT 142, in one configuration, is capable of managing up to 52 PONs. Alternatively, OLT can control more than 52 PONs depending on the structure of the optical communications network. Multiple PONs 144-146 are coupled to multiple ODNs 110-111, as illustrated in FIG. 1A, wherein a function of an ODN is to split a single optical fiber into multiple optical fibers. For example, PON 144 feeds a single optical fiber to ODN 110 and ODN 110 subsequently splits the single optical fiber to multiple optical fibers feeding to multiple ONTs including ONT(s) at ONTs 114 or 115. In one embodiment, OLT 142 is configured to include a signaling value verification mechanism for error detections.

Referring back to FIG. 1A, NMS 148 is used to maintain and monitor a communications network. For example, NMS 148 provides functions for controlling, planning, allocating, deploying, coordinating, and monitoring the resources of a network, including performing functions, such as fault management, configuration management, accounting management, performance management, and security management (“FCAPS”). The fault management is configured to identify, correct and store faults that occur in an optical network. While the configuration management identifies, simplifies, and tracks the network configuration, the accounting management identifies and collects usage statistics for the customers or users. Also, the performance management determines the efficiency of the current network, such as throughput, percentage utilization, error rates and response time. It should be noted that performance thresholds can trigger alarms and alerts. Security management maintains a process of controlling access to the network.

The signaling value verification mechanism may be activated upon receipt of a testing request. The testing request may be generated by an invalid signaling condition occurred during a system maintenance operation or due to an operator input or an error condition defined by the network operator. For example, a testing request may be issued if the OLT receives an illegal signaling from an ONT. In addition to a standard signaling test such as a GR-909 system self test, the signaling value verification mechanism, for example, includes 16 signaling values test sequence relating to voice operations. For instance, when both OLT and ONT enter the test mode, OLT runs 16 cycles that both OLT and ONT step through all 16 signaling values to identify whether all of the signaling values reach their destination(s) correctly.

In one embodiment, a fixed period of time such as 100 milliseconds is used for an ONT to resend its received content back to the OLT. When OLT receives the content sent by the ONT, it determines whether the paths or channels are working correctly in response to the content that OLT received. If the OLT fails to receive any response back from ONT within the 100 milliseconds, the network operator will be notified or alerted about the plain old telephone service (“POTS”) signaling failure. After completing the test, the OLT provides test results to the operator or system controller.

In an alternative embodiment, an ONT is capable of responding to an OLT using automatic identification system (“AIS”) signaling when it receives an inappropriate signaling value. The inappropriate signaling value can be any invalid signaling values such as a ringing signaling value for greater than 5 seconds. AIS signaling, for instance, will alert the OLT and network operator. The network operator activates the signaling value verification mechanism or an enhanced GR-909 self test, which incorporates various capabilities of the signaling value verification mechanism, to isolate the source of the problem. An ONT and OLT, in one aspect, are capable of using open manage client instrumentation (“OMCI”) messages to indicate whether the signaling values have accurately reached to their destinations between the ONT and OLT.

FIG. 1B is an optical communications network 190 illustrating a FTTN network architecture using a signaling value verification mechanism in accordance with one embodiment of the present invention. FTTN, which is also known as fiber to the node, fiber to the neighborhood, or fiber to the cabinet, is an optical communication network using fiber optic cables reach to a cabinet for providing network services to a neighborhood. Users can connect to the cabinet using coaxial cable(s) or twisted pair cable(s). The neighborhood served by the FTTC is usually around 5,000 feet or less between the cabinet and users.

Network 190 includes an optical network unit (“ONU”) 198, cables 194, and local network connector 196. ONU 198 is capable of communicating with PON 144 using optical signals while it is also capable of communicating with local network connector 196 using electrical signals. Cable 194 may be a coaxial cable or twisted pair wherein the range of cable 194 is usually less than 5,000 feet. In one embodiment, ONU 198 is configured to include an ECC device, which enables ONU 198 to detect and correct any error(s) before it passes the data onto the next managed entity such as splitter 192.

It should be noted that the exemplary embodiment(s) of the signaling value verification mechanism can be employed in any FTTX network architectures for isolating potential device and/or system hardware failures. An advantage of using the signaling value verification mechanism is to detect potential hardware defects to reduce system down time.

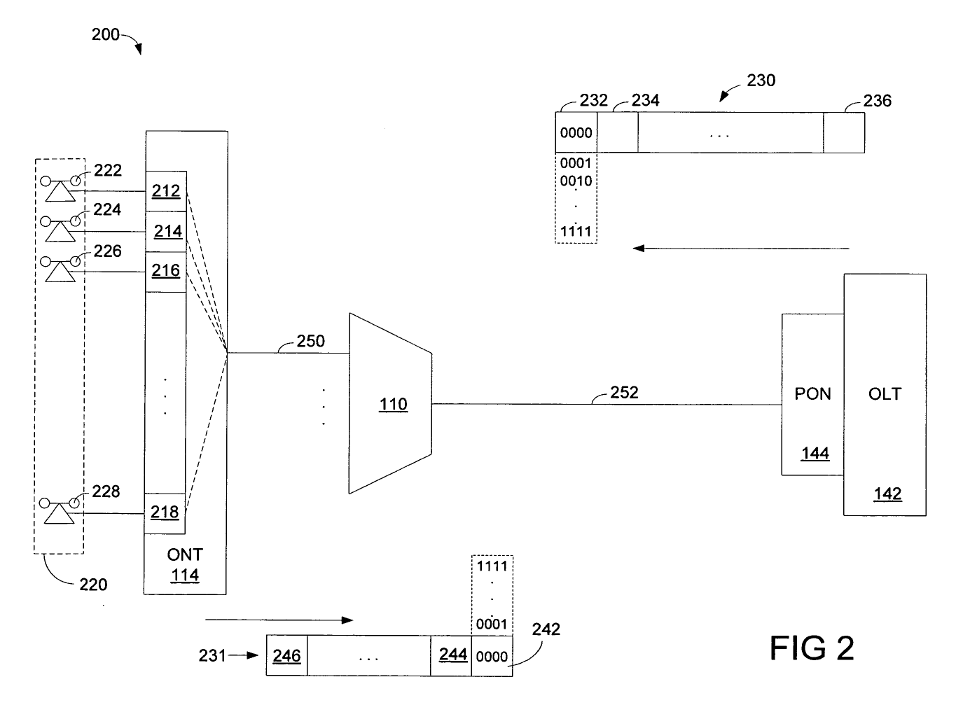

FIG. 2 is a block diagram illustrating an optical communication network 200 using a signaling value verification mechanism in accordance with one embodiment of the present invention. Network 200 illustrates an OLT 142, a PON 144, an ODN 110, and an ONT 114. Optical fibers 250-252 are used to provide data communications between OLT 142, PON 144, ODN 110, and ONT 114. It should be noted that the underlying concept of the embodiment does not change if one or more functional elements were added to or removed from network 200.

Referring back to FIG. 2, ONT 114 is coupled to multiple local phones 222-228, via its signaling value distributors 212-218. It should be noted phones 222-228 can be wired phones connected through telephone lines or wireless phones connected through a local wireless network. ONT 114, in one example, is capable of supporting up to 16 phones. Alternatively, ONT 114 may be configured to support more than 16 phones depending on the layout of ONT 114. It should be noted that ONT 114 is also capable of supporting voice, data, video, or a combination of voice, data, and video communications.

To communicate between OLT 142 and ONT 114, 64-bit signaling packets 230-231 can be used. Signaling packets 230-231 are organized into 16 4-bit sub-packets wherein each 4-bit sub-packet is capable of carrying 1 of 16 commands for a voice signaling or command. For example, signaling packet 230, which includes a header, not shown in FIG. 2, indicating it is a signaling packet as oppose to a data packet, includes 16 4-bit sub-packets 232-238. Each sub-packet is designated to one particular local voice device. For example, 4-bit sub-packet 232 may be a command for controlling phone 222 via signaling value distributor 212. Each 4-bit sub-packet 232 or 238 is capable of encoding 1 of 16 commands such as ringing or denying service. Similarly, 4-bit sub-packets 242-246 are capable of containing similar commands as sub-packet 232. In one embodiment, sub-packet 231 is capable of indicating whether any one of phones 222-228 is on-hook or off-hook.

In operation, upon receipt of a testing request, OLT 142 and ONT 114 enter the test or verification mode. OLT 142 retrieves a predefined test sequence from a storage location and begins the test sequence by sending a series of signaling values to ONT 114. For example, OLT 142 sends 16 signaling values in a series stepping through the test sequence such as “0000” and “1111” to ONT 114. After entering the test mode, ONT 114, in one embodiment, retrieves a sequence of verifying data, which is the same sequence as the predefined test sequence. Upon receipt of the content sent by OLT 142, the content received is compared with the verifying data. ONT 114 sends a reply message to OLT 142 indicating it has received correct data from OLT 142 if the content received matches with the verifying data. Alternatively, ONT 114 sends an incorrect reply message to OLT 142 if the content received mismatches with the verifying data. OLT 142 will report the result of the test to the network operator.

Alternatively, upon receipt of the content from OLT 142, ONT 114 resends the received content back to OLT 142. Upon receipt of the content from ONT 114, OLT 142 determines whether ONT 114 is able to receive the signaling data correctly. For example, if there is a hardware error such as a failed card, the value may be stuck to a fixed value and it will not change. OLT 142 can isolate the failure based on the reply messages received from the ONTs. Similarly, ONT is also capable of composing a testing sequence to examine the communication channel between ONT and OLT.

The exemplary embodiment of the present invention includes various processing steps, which will be described below. The steps of the embodiment may be embodied in machine or computer executable instructions. The instructions can be used to cause a general purpose or special purpose system, which is programmed with the instructions, to perform the steps of the exemplary embodiment of the present invention. Alternatively, the steps of the exemplary embodiment of the present invention may be performed by specific hardware components that contain hard-wired logic for performing the steps, or by any combination of programmed computer components and custom hardware components. While embodiments of the present invention will be described with reference to the Internet, the method and apparatus described herein is equally applicable to other network infrastructures or other data communications environments.

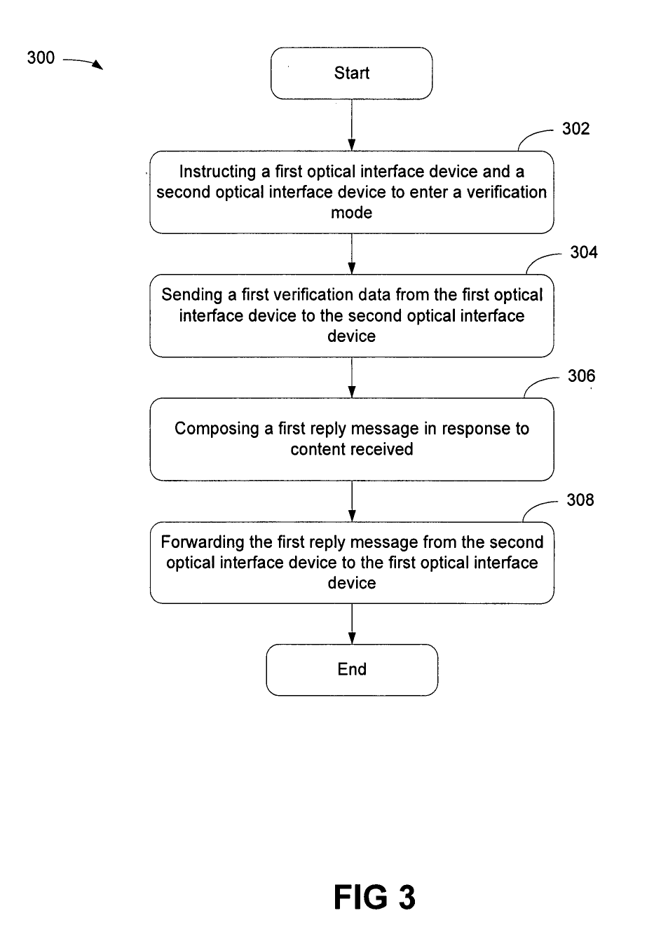

FIG. 3 is a flowchart 300 illustrating a process of using a signaling value verification mechanism to verify system performance in accordance with one embodiment of the present invention. At block 302, the process instructs the first optical interface device and the second optical interface device to enter a verification mode. For example, the process signals an OLT and an ONT to suspend normal communication mode and switch the test mode. After block 302, the process moves to the next block.

At block 304, the process sends first verification data from the first optical interface device to the second optical interface device via an optical communications network. For example, an OLT sends one of sixteen signaling values relating to voice communication to an ONT. It should be noted that the sequence of the sixteen signaling values is predefined. After block 304, the process proceeds to the next block.

At block 306, the process composes the first reply message in response to content received by the second optical interface in accordance with the first verification data. For example, the process may insert the content received by the second optical interface device into the first reply message before it is being sent to the OLT. Alternatively, after retrieving a predefined expected first signaling value from a storage location, the process compares the content received with the predefined expected first signaling value. The predefined expected first signaling value, also referred as verifying data, has the same value as the first verification data. The first reply message is composed with a correct acknowledgement if the content received matches with the predefined expected first signaling value. On the other hand, the first reply message composes an incorrect message if the content received mismatches with the predefined expected first signaling value. After block 306, the process moves to the next block.

At block 308, the process forwards the first reply message from the second optical interface device to the first optical interface device. In one embodiment, the process verifies the first reply message in response to the first verification data after the first reply message reaches to the first optical interface device. Upon sending second verification data from the first optical interface device to the second optical interface device via the optical communications network, the process composes a second reply message in accordance with content received by the second optical interface device in response to the second verification data. The second message is subsequently forwarded from the second optical interface device to the first optical interface device. In one embodiment, the process retrieves a group of verification data from a storage location, wherein the verification data includes a predefined testing sequence in accordance with a testing request. The process, in one embodiment, is further capable of receiving a test request, and subsequently issuing a test instruction in response to the testing request. After block 308, upon reporting the test result, the process ends.

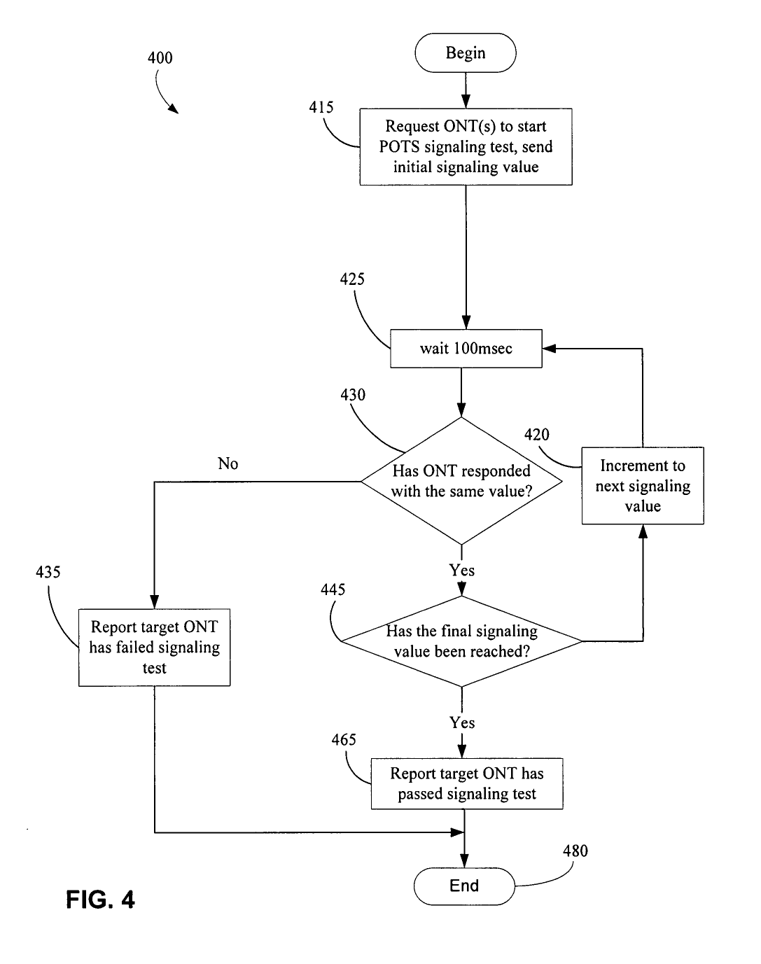

FIG. 4 is a flowchart 400 illustrating an alternative example of a signaling value verification mechanism to verify system performance in accordance with one embodiment of the present invention. At block 415, the process requests an ONT(s) to start POTS signaling test, and subsequently sends an initial signaling value. In one embodiment, the process issues the signaling test in response to a request. It should be noted that a network operator can request a signaling test anytime. Alternatively, the request could be issued by a routine of system maintenance operation. For example, the request may be issued by the routine 1 A.M. every morning. The signaling test or signaling value verification mechanism is capable of detecting hardware failures such as broken lines, off-hook phones, memory chips, or the like. Both ONT and OLT enter the test mode and step through the signaling test sequence to test parameters of interface devices. After block 415, the process moves to the next block.

At block 425, the process waits for a predefined fixed period time such as 100 ms. In one embodiment, the test sequence includes 16 values such as 0000, 0001 . . . 1111, and waits 100 ms for each value to be sent. If a value is stuck due to a hardware error such as a broken line, the value may not change within 100 ms. After block 425, the process moves to the next block.

At block 430, the process examines whether the ONT has responded with the same value. If the ONT fails to respond the same value, the process proceeds to block 435. Otherwise, the process proceeds to block 445.

At block 445, the process examines whether the final signaling value has reached. If the final signaling value reaches its destination, the process proceeds to block 465. Otherwise, the process moves to the block 420.

At block 420, the process retrieves the next signaling value in accordance with the test sequence and proceeds to block 425.

At block 465, the process provides a status report indicating that the target ONT has passed the signaling test. After this block, the process moves to block 480.

At block 436, the process provides a status report indicating that the target ONT has failed the signaling test. After block 436, the process moves to the next block.

At block 480, the process provides a report relating to the test results. The process ends.

While particular embodiments of the present invention have been shown and described, it will be obvious to those skilled in the art that, based upon the teachings herein, changes and modifications may be made without departing from this exemplary embodiment(s) of the present invention and its broader aspects. Therefore, the appended claims are intended to encompass within their scope all such changes and modifications as are within the true spirit and scope of this exemplary embodiment(s) of the present invention.

What is claimed is:

1. A method for verifying signaling values comprising:
instructing a first optical interface device and a second optical interface device to enter a verification mode;
sending a first verification data from the first optical interface device to the second optical interface device via an optical communications network;
composing a first reply message in response to content received by the second optical interface in accordance with the first verification data; and
forwarding the first reply message from the second optical interface device to the first optical interface device.

2. The method of claim 1, further comprising verifying the first reply message in response to the first verification data after the first reply message reaches to the first optical interface device.

3. The method of claim 2, further comprising:
sending a second verification data from the first optical interface device to the second optical interface device via the optical communications network;
composing a second reply message in accordance with content received by the second optical interface device in response to the second verification data; and
forwarding the second reply message from the second optical interface device to the first optical interface device.

4. The method of claim 1, wherein instructing a first optical interface device and a second optical interface device to enter a verification mode further includes:
signaling an optical line terminal (“OLT”) to enter a test mode; and
instructing an optical network terminal (“ONT”) to enter a test mode.

5. The method of claim 4,
wherein signaling an optical line termination (“OLT”) to enter a test mode further includes suspending normal communication mode; and
wherein instructing an optical network terminal (“ONT”) to enter a test mode further includes suspending normal communication mode.

6. The method of claim 1, further comprising retrieving a group of verification data from a storage location, wherein retrieving a group of verification data further includes identifying a predefined testing sequence in accordance with a testing request.

7. The method of claim 1, further includes:
receiving a testing request; and
issuing a testing instruction in response to the testing request.

8. The method of claim 1, wherein sending a first verification data further includes sending one of sixteen signaling values from an optical line termination (“OLT”) to an optical network terminal (“ONT”).

9. The method of claim 1, wherein composing a first reply message further includes inserting the content received by the second optical interface device into the first reply message.

10. The method of claim 1, wherein composing a first reply message further includes:
retrieving a predefined expected first signaling value;
comparing the content received with the predefined expected first signaling value;
composing the first reply message with a correct acknowledgement if the content received matches with the predefined expected first signaling value; and
composing the first reply message with an incorrect message if the content received mismatches with the predefined expected first signaling value.

11. A method for verifying signaling values comprising:
instructing an optical line termination (“OLT”) and an optical network terminal (“ONT”) to enter a test mode;
sending a first signaling value from the OLT to the ONT via an optical communications network;
composing a first reply message indicating content received by the ONT in response to the first signaling value; and
forwarding the first reply message from the ONT to the OLT via the optical communications network.

12. The method of claim 11, further comprising:
verifying the first reply message in response to the first signaling value after the OLT receives the first reply message; and
raising an alarm if the first reply message fails to verify with the first signaling value.

13. The method of claim 11, further comprising:
verifying the first reply message in response to the first signaling value after the OLT receives the first reply message;
sending a second signaling value from the OLT to the ONT via the optical communications network;
composing a second reply message indicating content of the second signaling value received by the ONT; and
forwarding the second reply message from the ONT to the OLT via the optical communications network.

14. The method of claim 11, wherein composing a first reply message further includes inserting the content received by the ONT to a first portion of the first reply message.

15. The method of claim 14, wherein composing a first reply message further includes padding one of sixteen testing signaling values to a second portion of the first reply message.

16. A system for verifying signaling values comprising:
means for instructing a first optical interface device and a second optical interface device to enter a verification mode;
means for sending a first verification data from the first optical interface device to the second optical interface device via an optical communications network;
means for composing a first reply message in response to content received by the second optical interface in accordance with the first verification data; and
means for forwarding the first reply message from the second optical interface device to the first optical interface device.

17. The system of claim 16, further comprising means for verifying the first reply message in response to the first verification data after the first reply message reaches to the first optical interface device.

18. The system of claim 17, further comprising:
means for sending a second verification data from the first optical interface device to the second optical interface device via the optical communications network;
means for composing a second reply message in accordance with content received by the second optical interface device in response to the second verification data; and
means for forwarding the second reply message from the second optical interface device to the first optical interface device.

19. The system of claim 16, wherein means for instructing a first optical interface device and a second optical interface device to enter a verification mode further includes:
means for signaling an optical line terminal (“OLT”) to enter a test mode; and
means for instructing an optical network terminal (“ONT”) to enter a test mode.

20. The system of claim 19,
wherein means for signaling an optical line termination (“OLT”) to enter a test mode further includes means for suspending normal communication mode; and
wherein means for instructing an optical network terminal (“ONT”) to enter a test mode further includes means for suspending normal communication mode.

21. The system of claim 16, further comprising means for retrieving a group of verification data from a storage location, wherein means for retrieving a group of verification data further includes means for identifying a predefined testing sequence in accordance with a test request.

22. The system of claim 16, further includes:
means for receiving a test request; and
means for issuing a testing instruction in response to the test request.

23. The system of claim 16, wherein means for sending a first verification data further includes means for sending one of sixteen signaling values from an optical line termination (“OLT”) to an optical network terminal (“ONT”).
